(19) United States
(12) Patent Application Publication
(10) Pub. No.: US 2019/0165633 A1
(43) Pub. Date: May 30, 2019

(54) INTEGRATED POWER-CONNECTED APPARATUS HAVING DRIVING CONTROLLER AND ELECTRIC MOTOR

(71) Applicant: INDUSTRIAL TECHNOLOGY RESEARCH INSTITUE, Hsin-chu (TW)

(72) Inventors: Huan-Lung Gu, Hualien City (TW); Shao-Yu Lee, Hsinchu County (TW); Shih-Kai Hsieh, Taoyuan (TW); Shih-Hsiang Chien, Yilan County (TW)

(21) Appl. No.: 15/846,753

(22) Filed: Dec. 19, 2017

(30) Foreign Application Priority Data
Nov. 30, 2017 (TW) 106141936

(51) Int. Cl. H02K 3/50; H02K 11/33; H02K 5/22; H02K 5/18

(52) U.S. Cl. CPC H02K 3/50; H02K 5/18; H02K 5/225; H02K 11/33

(57) ABSTRACT

An integrated power-connected apparatus having a driving controller and an electric motor includes an electric motor, a driving controller, at least one conductive pillar, a cooler and at least one electric insulating tube. The electric motor has a rotor and a stator. The driving controller includes a power module and a control module. The at least one conductive pillar has one end thereof to electrically couple the stator, while another end thereof connects the power module. The cooler, located between the electric motor and the power module, allows the at least one conductive pillar to penetrate therethrough. The at least one electric insulating tube sleeves the at least one conductive pillar and isolates electrically the at least one conductive pillar from the control module and the cooler.

### CROSS REFERENCE TO RELATED APPLICATION

The present application is based on, and claims priority from, Taiwan Application Serial Number 106141936, filed on Nov. 30, 2017, the disclosure of which is hereby incorporated by reference herein in its entirety.

### TECHNICAL FIELD

The present disclosure relates in general to an integrated power-connected apparatus having a driving controller and an electric motor, and more particularly to an integrated power-connected apparatus that utilizes conductive pillars to penetrate a cooler thereto so as to couple a driving controller and an electric motor.

### BACKGROUND

A driving controller (or simply called as a controller) of electric motor generally includes a control board, a power module (specifically, an intelligence power module, IPM) and a gate driver. According to different power styles, the general driving controller is usually consisted of a control module and a power module. The control module uses a small-power current to generate control signals, while the power module can receive a larger external power (a battery power for example). The incoming larger external power to the power module is firstly processed and controlled by the control signals of the control module, and then a proper scale of the larger power can be provided to stator coils of the electric motor. The proper-scaled power flowing in the stator coils would induce an electromagnetic field to move a rotor of the electric motor, such that a kinetic energy can be generated for output. In the case that the aforesaid mechanism is driven in a reverse direction, then a total different function would be generated. Namely, if the rotor of the electric motor is turned by external forcing, then the electric motor would be functioned as a generator. In this situation, the stator coils, mainly to form a generator, would generate a large power for the power module to receive. After being processed and modulated by the control signals of the control module, the large power would be outputted for further usage; for example, to be stored into a battery or cell.

Recently, with the progress in electronic technology, a volume of the driving controller has been significantly reduced so as to increase the corresponding power density, by which the mechatronics (i.e. mechanical-electrical integration) would be greatly benefited. However, though the volume is reduced, yet the work power is still held high, since the driving controller keeps providing a high-power current for the electric motor. Thereupon, the driving controller would still work and under a high temperature environment formed by its own heat that can't be dissipated effectively and efficiently. As a consequence, if the heat cannot be dissipated, the driving controller would be eventually burned out.

In mechatronics, while in mounting a hardware of the driving controller to an end portion of a shaft of the electric motor, two problems are usually raised yet and urgent to be resolved.

One of these two problems is at coiling of power lines of the stator coils in the electric motor, in which difficulty in arranging ends of individual power lines is usually met. It is well known that, in correspondence with phase number and pole number of each stator, a plurality of coils are furnished to allow flowing of electric currents to induce corresponding electromagnetic fields. In this arrangement, each the coil has a flow-in end and an opposing flow-out end. Namely, each the coil has two ends of the power line. To integrate winding of all these coils, the ends of the power lines shall be properly connected by soldering or the like means. Further, the coils shall be connected with a power supply cable of the driving controller so as to receive power. By having a three-phase electric motor as an example, ends of the power lines for the coils would be arranged to connect with a common ground or three individual outgoing ports, such that a specific winding pattern for the stator can be formed, such as a Y-type winding, a A-type winding or the like. In general, each phase accounts for at least one individual outgoing port. Such an arrangement of connecting the outgoing ports with the corresponding ends of the power lines can be done only after all individual coils have been assembled to the stator (a unit of silicon steel plates). It means that all the work for connecting the ends of the power lines is performed in a corresponding internal room at a respective end of the shaft inside an outer casing that locates thereinside the stator of the electric motor. Apparently, the room is definitely too narrow so as not easy to process the connection of ends of the power lines, and thus quality in assembling would be low. As long as the connections of the ends of the power lines are done, a power output end of the driving controller shall be assembled. Since the assembly work is performed also at the lateral side of the end of the shaft in the outer casing, the assembling work would face the same difficult spatial problem, where the spacing between two adjacent coils of the driving controller is definitely limited again. No matter the aforesaid connection is performed by soldering or being locked, the assembly work would be difficult and generally needs an additional longer conductive wire for fulfilling the connection. However, if the conductive wire is too long, then it shall be bent and squeezed into the tiny lateral room aside the end of the shaft, and thus both the corresponding electric impedance and the corresponding heat loss would be increased. Thereupon, the aforesaid soldering connections would be gradually weakened, and eventually would face a risk of falling apart.

Another is a heat-dissipation problem within the limited internal space. It is always crucial and bothering to design a satisfied heat-dissipation mechanism for the driving controller within such a limited space in the corresponding casing. In general, heat of the driving controller is dissipated in an air-cool or water-cool manner. In practice, heat-dissipation is one of daily problems that a mechatronic electric motor shall meet. If this problem is not properly handled, all the circuit elements of the driving controller would always face a jeopardy of burning down.

Nevertheless, in the art, in order to increase the power density of a power system, the output power shall be increased, while the total volume is reduced. Actually, it has become the mainstream in the field of electric power products (such as an electric vehicle) to achieve minimal volume in mechatronics, i.e. to integrate an electric motor and hardware of driving controller into a single device so as to minimize the occupation of the device. However, in mechatronics, the limited space available for assembling is still yet to be resolved. Generally, following disadvantages at least did usually go with the aforesaid spatial problem. They are difficulty in design, difficulty in assembling, difficulty in heat dissipating, downgraded quality and so on. All the aforesaid disadvantages are not localized, but prevail in all fields related to the electric motors around the world. Also, they form an inevitable harsh task to the art upon when a new product is developed.

Accordingly, by aiming at the difficulty of arranging power lines and the poor performance in heat dissipation at the driving controller in mechatronics, an improvement upon an integrated power-connected apparatus having a driving controller and an electric motor that is featured in a simple design, easy assembling, high heat-dissipating ability and a satisfied assembling quality is definitely urgent and welcome to the skilled person in the art.

### SUMMARY

In one embodiment of the disclosure, an integrated power-connected apparatus having a driving controller and an electric motor includes an electric motor, a driving controller, at least one conductive pillar, a cooler and at least one electric insulating tube. The electric motor has a rotor and a stator. The driving controller includes a power module and a control module. The at least one conductive pillar has one end thereof to electrically couple the stator, while another end thereof connects the power module. The cooler, located between the electric motor and the power module, allows the at least one conductive pillar to penetrate therethrough. The at least one electric insulating tube, sleeving the at least one conductive pillar, isolates electrically the at least one conductive pillar from the control module and the cooler.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic exploded view of an embodiment of the integrated power-connected apparatus in accordance with this disclosure;

FIG. 2 is a schematic view showing an assembly of the conductive pillar and the electric insulating tube in accordance with this disclosure;

FIG. 3 is a schematic view of an embodiment of the fastening mechanism according to this disclosure, in a form having a screw nut;

FIG. 4A is a schematic view of another embodiment of the fastening mechanism according to this disclosure, in a form having an insert pin;

FIG. 4B is a right side view of FIG. 4A;

FIG. 5A is a schematic view of a further embodiment of the fastening mechanism according to this disclosure, in a form having a snap ring;

FIG. 5B is a right side view of FIG. 5A;

FIG. 6 is a schematic exploded view of another embodiment of the conductive pillar according to this disclosure;

FIG. 7 is a schematic perspective view of an embodiment of the cooler according to this disclosure, in a form of heat fins;

FIG. 8 is a schematic perspective view of another embodiment of the cooler according to this disclosure, in a form of water cooling; and

FIG. 9 is a schematic perspective view of a further embodiment of the cooler according to this disclosure, in a form of heat pipes.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

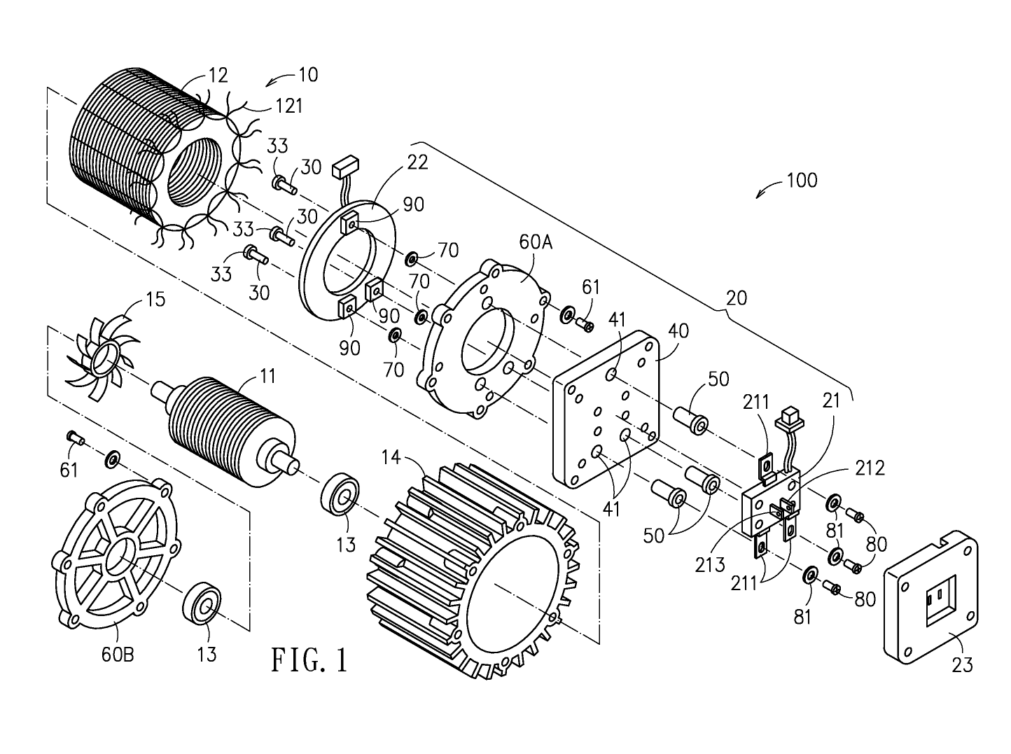

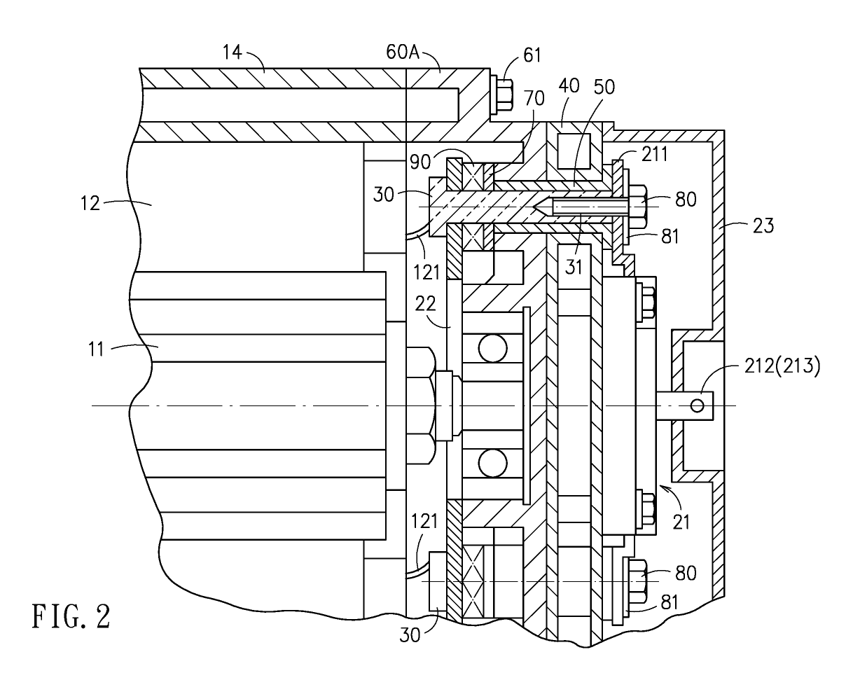

Referring now to FIG. 1 and FIG. 2, the integrated power-connected apparatus 100 having a driving controller and an electric motor mainly includes an electric motor 10, a driving controller 20, three conductive pillars 30, a cooler 40 and three electric insulating tubes 50. It shall be explained that, in this embodiment, the electric motor 10 having three phases is taken as a typical example. According to the winding type of motor coils, three conductive pillar 30 are applied to pair three electric insulating tubes 50. However, in practice, the number of the conductive pillars 30 and the number of the corresponding electric insulating tubes 50 are determined by the phase number and the winding type of the electric motor 10. Namely, a two-phase electric motor, two pairs of the conductive pillar 30 and the electric insulating tube 50 shall be needed. However, if the winding does not follow the aforesaid winding type, it may happen that more than two conductive pillars 30 can be applied to pair the same number of the electric insulating tubes 50.

The electric motor 10 has a rotor 11 and a stator 12. The rotor 11 is furnished with two bearings 13 located axially and oppositely to each other with respect to the rotor 11. The stator 12 is located inside an outer casing 14, and the rotor 11 is axially mounted inside the stator 12. In this embodiment, the outer casing 14 is, but not limited to, an air-cool structure. In particular, in this embodiment, a cooling fan 15 can be provided to the rotor 11 so as thereby to produce an enforced air flow into the stator 12.

The driving controller 20 includes a power module 21 and a control module 22. One end of the conductive pillar 30 is to collect electrically corresponding ends of electric wires 121 winding the stator 12, while another end thereof is connected electrically with a corresponding electric port 211 of the power module 21. The control module 22 is furnished with three current detectors 90. Each of the three conductive pillars 30 penetrates through the control module 22 and one corresponding current detector 90. In this embodiment, the current detector 90 mounted on the control module 22 is to measure the electric current, so that each said conductive pillar 30 is to penetrate through both the control module 22 and the corresponding current detector 90. However, since types of the current detector 90 may be various, the respective penetrating-through arrangement for the conductive pillar 30 might not be necessary or relevant to some types of the current detector. In addition, some electric motors might have a voltage value, not the current value, as its control reference or parameter, and thus no current detection is required. Hence, in these applications, a voltage detector, not the current detector any more, is needed, and each of the conductive pillars 30 is not necessary to penetrate through the control module 22. As shown in FIG. 1, a flange 33 can be constructed at the end of the conductive pillar 30 that collects and thus connects electrically the corresponding electric wires 121. The flange 33 is provided to facilitate the soldering of the electric wires 121 and helpfully to restrain the conductive pillar 30 at one side of the control module 22. In some other embodiments, the conductive pillar 30 can also be provided without the flange 33.

The cooler 40 is located between the electric motor 10 and the power module 21. Generally, operations of the power module 21 would produce lots of heat. Thus, special heat-dissipating arrangement shall be needed. In this embodiment, the cooler 40 is thus provided by including three assembly holes 41 for one said corresponding conductive pillar 30 to penetrate therethrough. The three electric insulating tubes 50 sleeve individually the three conductive pillars 30 so as to isolate electrically the corresponding conductive pillars 30 from the control module 22 as well as the cooler 40. Namely, each of the assembly holes 41 allows one pair of the electric insulating tube 50 and the conductive pillar 30 to penetrate through. In this disclosure, the heat source, i.e. the power module 21, is located at an outer side of the cooler 40 in a close manner, and thus also separated from the electric motor 10 and the control module 22 by the cooler 40. Since more space is available at the outer side of the cooler 40, it is much easier to work out a satisfied heat-dissipating scheme and to receive external power from an additional power source. In addition, the electric insulating tube 50 allows the conductive pillar 30 to penetrate safely (in an electric view) through the cooler 40 and to extend further to contact the electric port 211 of the power module 21, without a worry of electric leakage.

In addition, a rear bearing seat 60A, disposed between the cooler 40 and the control module 22, is used to receive one end of the rotor 11, with each of the conductive pillars 30 to penetrate through the rear bearing seat 60A. A front bearing seat 60B is disposed at another end of the rotor 11 by axially opposing to the rear bearing seat 60A with respect to the rotor 11. The rear bearing seat 60A and the front bearing seat 60B are individually fixed to two axial opposing ends of the outer casing 14, respectively, by screw bolt 61 (only one screw bolt shown in FIG. 1). Further, three insulation washers 70 are disposed between the rear bearing seat 60A and the control module 22, and each of the three conductive pillars 30 penetrates through one said corresponding insulation washer 70.

Accordingly, one axial end of the conductive pillar 30 is coupled with the stator 12, while another axial end thereof opposing to the former one is to penetrate orderly through the control module 22, the current detector 90, the insulation washer 70, the rear bearing seat 60A, the cooler 40 and the electric port 211. The electric insulating tube 50 sleeving the corresponding conductive pillar 30 is to penetrate the cooler 40 and the rear bearing seat 60A. Since the electric insulating tube 50 is made of a soft material, so even after the conductive pillar 30 penetrates loosely through the corresponding assembly hole 41 of the cooler 40, the electric insulating tube 50 can still sleeve the corresponding conductive pillar 30 and simultaneously penetrates through the assembly hole 41. Namely, since the assembly hole 41 has a larger size and the electric insulating tube 50 is soft, the electric insulating tube 50 can be easily mounted between the conductive pillar 30 and the cooler 40. Thereafter, the power module 21 can be mounted, so that the orderly axial arrangement of this disclosure from one axial end way-along to another axial end is completed. In establishing the whole apparatus, all the members are assembled in order and in the axial direction, and thus each addition of the members won't meet difficult-assembling even though the neighboring members might be in a tight fit. Thereupon, in comparison with the assembling work in the art, the entire assembling work in accordance with this disclosure is much simpler and easier to be carried out. As a consequence, the entire assembling efficiency would be higher, and damage rates of involved components, especially the stiffer power lines at corresponding soldering points, would be reduced. Namely, by providing this disclosure, the assembling quality can be substantially enhanced, but the assembling cost can be reduced.

Referring now to FIG. 2, the axial end of the conductive pillar 30 that approaches the electric port 211 is furnished with an axial drill hole having an internal thread 31. Then, a fastening mechanism 80 can be introduced to fix each individual conductive pillar 30. In this embodiment, the fastening mechanism 80 is embodied as a screw for pairing a washer 81, and the screw 80 is engaged with the internal thread 31 of the conductive pillar 30, such that the driving controller 20 (including the power module 21 and the control module 22), the cooler 40, the electric insulating tube 50 and the electric motor are integrated as one entirety.

In addition, a protective cover 23 is furnished to cover and thus shield the power module 21, but allows positive/negative electric contacts 212, 213 of the power module 21 to extend out of the protective cover 23 so as for receiving an external power, such as a battery (not shown in the figure) for providing positive/negative powers. The external power is then transformed into a three-phase alternating current by the power module 21, and at least three power output ports are provided to supply powers of individual phases to the stator 12. In this disclosure, the protective cover 23 can be fixed to the cooler 40 by screw bolts or the like means.

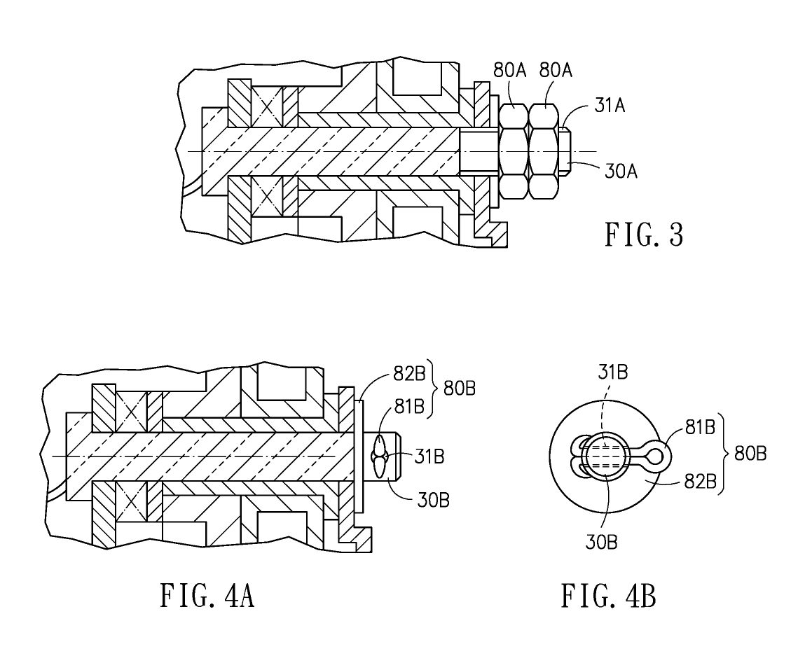

Referring now to FIG. 3, the fastening mechanism 80A can include two screw nuts. The conductive pillar 30A is furnished with an external thread 31A to pair the fastening mechanism 80A, i.e. the two screw nuts.

Referring now to FIG. 4A and FIG. 4B, the fastening mechanism 80B can include an insert pin 81B and a washer 82B. The conductive pillar 30B is furnished with a pin hole 31B for receiving the insert pin 81B to penetrate therethrough.

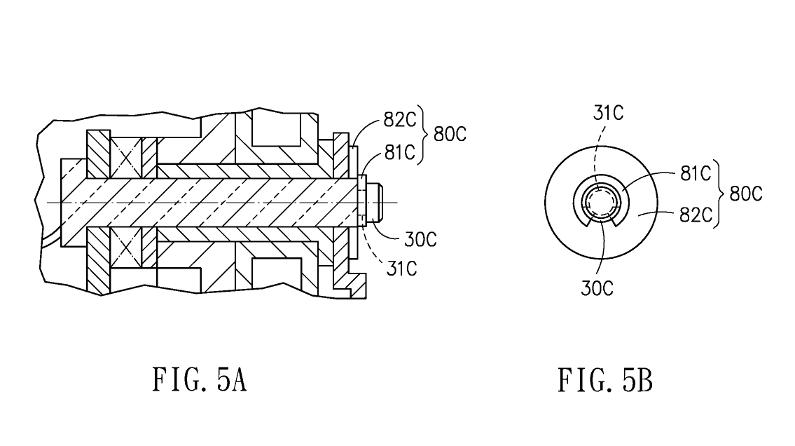

Referring now to FIG. 5A and FIG. 5B, the fastening mechanism 80C can include a snap ring 81C and a washer 82C. The conductive pillar 30C is furnished with a ring groove 31C for pairing the snap ring 81C.

In this disclosure, various fixation means can be adopted to fix the conductive pillar 30 to the electric port 211 of the power module 21. These fixation means can be, but not limited to, a soldering means, a riveting means, and the like.

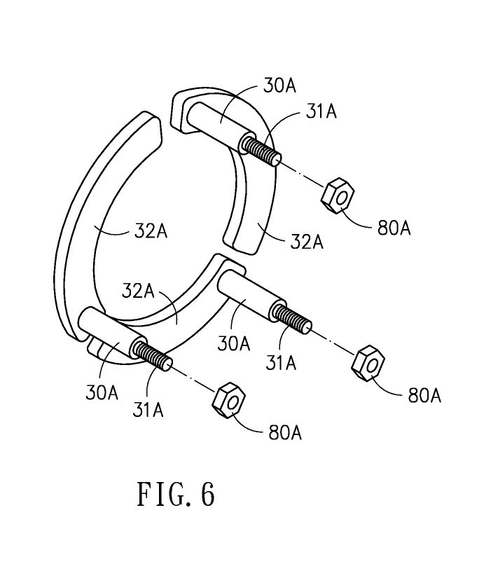

Referring now to the embodiment shown in FIG. 6, by having the conductive pillar 30A with the external thread 31A as a typical example, each of the conductive pillars 30A is to connect one corresponding conductive plate 32A. As shown in FIG. 6, the conductive plate 32A is largely shaped to be a circular section. The conductive pillar 30A is to engage the fastening mechanism 80 formed as a screw nut. The electric wire 121 of the stator 12 is connected with the corresponding conductive plate 32A. By applying this disclosure, the distance between the electric wire 121 and the conductive pillar 30A can be reduced. Further, the embodiment of the conductive plate 32A can be also applied to other types of conductive pillar such as that conductive pillars 30, 30B or 30C shown in FIG. 2, FIG. 4A, or FIG. 5A, respectively.

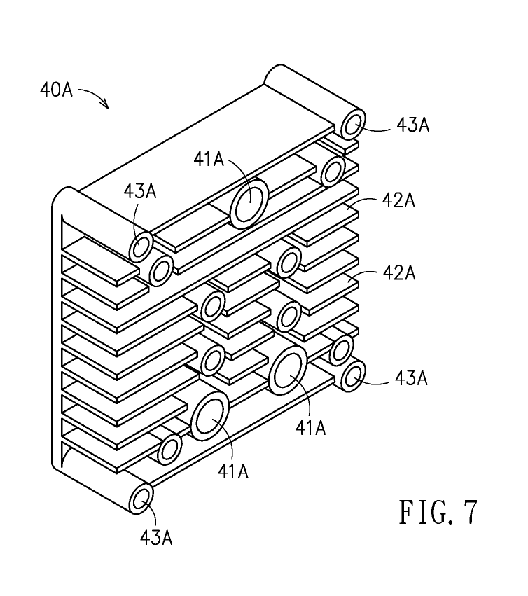

Referring now to FIG. 7, the cooler 40A includes three assembly holes 41A, a plurality of heat fins 42A and a plurality of screw holes 43A. The plurality of heat fins 42A and the assembly holes 41A are structurally connected for dissipating the heat generated by the power module 21 (see FIG. 1). The plurality of screw holes 43A located on the plurality of heat fins 42A provide connections to the power module 21. In this embodiment, the cooler 40A is an air-cool heat fin cooling device, and positions and shapes of the heat fins 42A can be arbitrarily determined according to practical needs. Of course, as the progress in material science, some materials do have a super-high heat-absorbing property. Also, in some applications, thermoelectric cooling may provide a cooling performance to satisfy the requirements demanded by the cooler 40A of this embodiment. Thus, in this situation, a well cooling performance may be achieved, even no heat-fin device is involved.

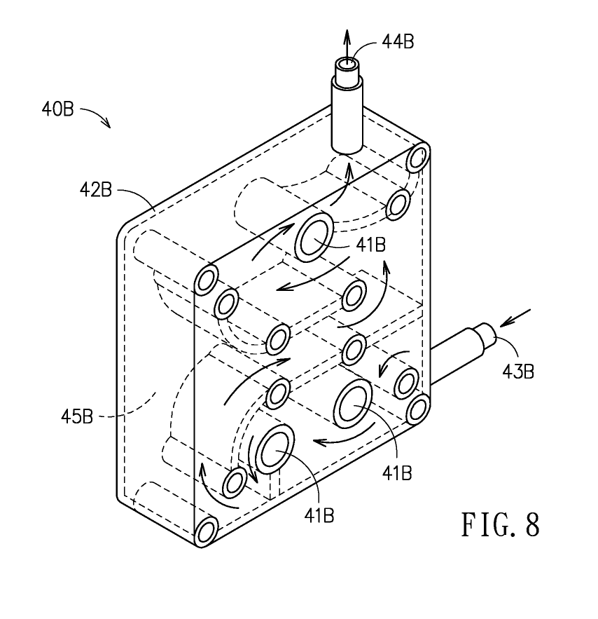

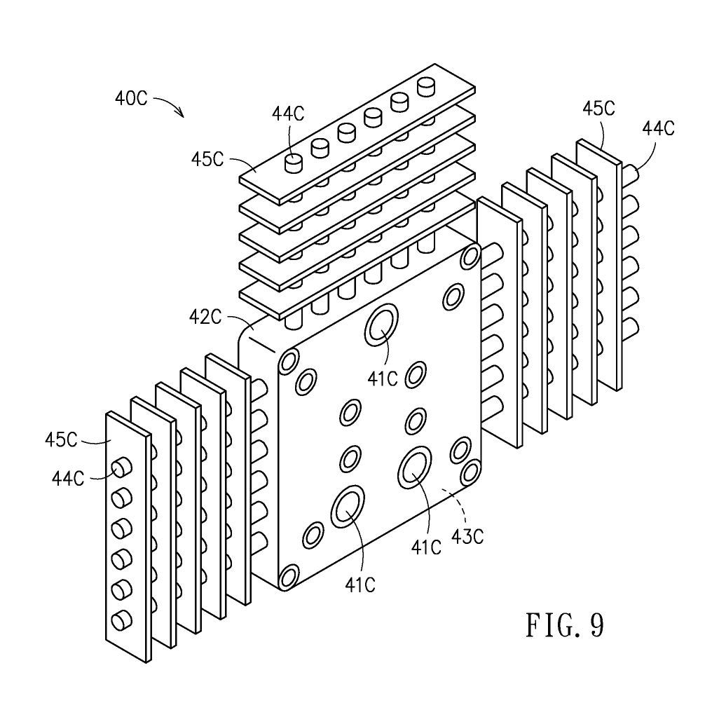

Referring now to FIG. 8, the cooler 40B includes a seal casing 42B. Three assembly holes 41B penetrates through the seal casing 42B. The seal casing 42B has a water inlet 43B, a water outlet 44B, and a fluid passageway 45B thereinside connecting spatially the water inlet 43B and the water outlet 44B. As shown, arrows in the fluid passageway 45B indicate the flow directions. It is noted that the fluid passageway 45B presents a winding route to make longer the water flow thereinside, such that more heat generated by the power module 21 can be exhausted by the cooler 40B. In this embodiment, the water-cool cooler 40B can vary positions and arrangements of the water inlet 43B, the water outlet 44B and the fluid passageway 45B arbitrarily per practical requirements.

Referring now to FIG. 9, the cooler 40C includes a seal casing 42C, a coolant 43C, a plurality of heat pipes 44C and a plurality of heat fins 45C. Three assembly holes 41C penetrates through the seal casing 42C. The coolant 43C is contained in the seal casing 42C. The plurality of heat pipes 44C are mutually connected and also connects spatially to the seal casing 42C. The plurality of heat fins 45C are connected structurally with the plurality of heat pipes 44C. The liquid-state coolant 43C would be vaporized after be heated, and the vapor-state coolant 43C would enter the plurality of heat pipes 44C from the seal casing 42C. The plurality of heat fins 45C would dissipate the heat of the vapor-state coolant 43C to the atmosphere. Inside the plurality of heat pipes 44C, the vapor-state coolant 43C would be condensed back to the liquid-state coolant 43 after the heat is dissipated. The liquid-state coolant 43C in the plurality of heat pipes 44C would flow back to the seal casing 42C. Thus, a heat-dissipation loop is formed. In this embodiment, the cooler 40C is a heat-pipe air-cooling device, and positions, numbers and arrangements of the heat pipes 44C and the heat fins 45C can vary arbitrarily per practical requirements.

In summary, the integrated power-connected apparatus having a driving controller and an electric motor provided by this disclosure applies pairs of the conductive pillar and the electric insulating tube to penetrate through the cooler so as to integrate the driving controller and the electric motor at opposing ends of the cooler. Thereupon, the shortcomings in the difficulty of arranging power lines at the electric motor and the poor performance in heat dissipation at the driving controller in general mechatronics can be resolved. Also, the integrated power-connected apparatus having a driving controller and an electric motor in this disclosure is obviously superior in a simple design, easy assembling, high heat-dissipating ability and a satisfied assembling quality.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An integrated power-connected apparatus having a driving controller and an electric motor, comprising:
an electric motor, having a rotor and a stator;
a driving controller, including a power module and a control module;
at least one conductive pillar, having one end thereof to electrically couple the stator, while another end thereof connects the power module;
a cooler, disposed between the electric motor and the power module, the at least one conductive pillar penetrating through the cooler; and
at least one electric insulating tube, sleeving the at least one conductive pillar, being to electrically isolate the at least one conductive pillar from the control module and the cooler.

2. The integrated power-connected apparatus having a driving controller and an electric motor of claim 1, wherein the cooler includes at least one assembly hole for allowing the at least one electric insulating tube and the at least one conductive pillar to penetrate therethrough.

3. The integrated power-connected apparatus having a driving controller and an electric motor of claim 2, wherein the cooler includes:
at least one heat fin for heat-dissipating the power module, structurally connecting the at least one assembly hole; and
at least one screw hole for connecting the power module, located at the at least one heat fin.

4. The integrated power-connected apparatus having a driving controller and an electric motor of claim 2, wherein the cooler includes:
a seal casing, the at least one assembly hole penetrating through the seal casing;
a coolant, contained inside the seal casing;
at least one heat pipe, connecting structurally and spatially the seal casing; and
at least one heat fin, connecting structurally the at least one heat pipe.

5. The integrated power-connected apparatus having a driving controller and an electric motor of claim 2, wherein the cooler includes a seal casing having a water inlet and a water outlet, the seal casing further having a fluid passageway thereinside to connect spatially the water inlet and the water outlet.

6. The integrated power-connected apparatus having a driving controller and an electric motor of claim 1, further including a rear bearing seat located between the cooler and the control module for mounting the rotor, the at least one conductive pillar penetrating through the rear bearing seat.

7. The integrated power-connected apparatus having a driving controller and an electric motor of claim 6, further including at least one insulation washer located between the rear bearing seat and the control module, the at least one conductive pillar penetrating through the at least one insulation washer.

8. The integrated power-connected apparatus having a driving controller and an electric motor of claim 1, further including a conductive plate connecting structurally the at least one conductive pillar, electric lines of the stator being connected with the conductive plate.

9. The integrated power-connected apparatus having a driving controller and an electric motor of claim 1, further including a fastening mechanism for fixing the at least one conductive pillar so as to integrate the driving controller, the cooler, the electric insulating tube and the electric motor as one entirety.

10. The integrated power-connected apparatus having a driving controller and an electric motor of claim 9, wherein the fastening mechanism is a screw for engaging a thread of the at least one conductive pillar.

11. The integrated power-connected apparatus having a driving controller and an electric motor oh claim 9, wherein the fastening mechanism is at least one screw nut , the at least one screw nut for engaging a thread of the at least one conductive pillar.

12. The integrated power-connected apparatus having a driving controller and an electric motor oh claim 9, wherein the fastening mechanism includes an insert pin and a washer, the insert pin being to pair a pin hole of the at least one conductive pillar.

13. The integrated power-connected apparatus having a driving controller and an electric motor oh claim 9, wherein the fastening mechanism includes a snap ring and a washer, the snap ring being to pair a ring groove of the at least one conductive pillar.

14. The integrated power-connected apparatus having a driving controller and an electric motor of claim 1, wherein the at least one conductive pillar penetrates through the control module.

15. The integrated power-connected apparatus having a driving controller and an electric motor of claim 1, further including at least one current detector located at the control module, the at least one conductive pillar penetrating through the at least one current detector.
